(19) United States
(12) Patent Application Publication
(10) Pub. No.: US 2015/0289127 A1
(43) Pub. Date: Oct. 8, 2015

(54) METHOD AND APPARATUS FOR PROVIDING PROXIMITY INFORMATION IN A WIRELESS COMMUNICATION SYSTEM

(71) Applicant: INNOVATIVE SONIC CORPORATION, Taipei City (TW)

(72) Inventors: Meng-Hui Ou, Taipei City (TW); Yu-Hsuan Guo, Taipei City (TW)

(21) Appl. No.: 14/674,690

(22) Filed: Mar. 31, 2015

Related U.S. Application Data
(60) Provisional application No. 61/974,051, filed on Apr. 2, 2014.

(51) Int. Cl. H04W 8/00; H04W 72/04; H04W 4/00; H04W 64/00

(52) U.S. Cl. CPC H04W 8/005; H04W 64/006; H04W 72/048; H04W 4/008; H04W 88/06

(57) ABSTRACT

A method and apparatus for a providing proximity information are disclosed. The method includes a first UE transmitting a report that includes at least the proximity information and a location information of the first UE to a network, wherein the proximity information is at least about the first UE discovering a second UE.

### CROSS-REFERENCE TO RELATED APPLICATIONS

The present application claims the benefit of U.S. Provisional Patent Application Ser. No. 61/974,051 filed on Apr. 2, 2014, the entire disclosure of which is incorporated herein by reference.

### FIELD

This disclosure generally relates to wireless communication networks, and more particularly, to a method and apparatus for providing proximity information in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus for providing proximity information are disclosed. The method includes a first UE transmitting a report that includes at least a proximity information and a location information of the first UE to a network, wherein the proximity information is at least about the first UE discovering a second UE.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a reproduction of Figure 5.3.2-1 of 3GPP TS 23.303.

FIG. 6 is a reproduction of Figure 5.3.4.1-1 of 3GPP TS 23.303.

FIG. 7 is a reproduction of Figure 5.5.2-1 of 3GPP TS 23.303.

FIG. 8 is a reproduction of Figure 5.5.5-1 of 3GPP TS 23.303.

FIG. 9 is a reproduction of Figure 5.5.6-1 of 3GPP TS 23.303.

FIG. 10 is a message flow chart according to one exemplary embodiment.

FIG. 11 is a flow chart according to one exemplary embodiment.

FIG. 12 is a flow chart according to one exemplary embodiment.

FIG. 13 is a flow chart according to one exemplary embodiment.

FIG. 14 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including TR 22.803 v12.2.0, “Feasibility study for Proximity Services (ProSe) (Release 12)”; TS 23.303 v12.0.0, “Proximity-based services (ProSe); Stage 2 (Release 12)”; TS 36.331 v12.0.0, “E-UTRA; Radio Resource Control (RRC); Protocol specification (Release 12)”; TS 36.355 v12.1.0, “E-UTRA; LTE Positioning Protocol (LPP) (Release 12)”; TR 36.843, “Study on LTE Device to Device Proximity services (Release 12)”; and TS 36.321 v12.0.0, “E-UTRA; Medium Access Control (MAC) protocol specification (Release 12)”. The standards and documents listed above are hereby expressly incorporated by reference in their entirety.

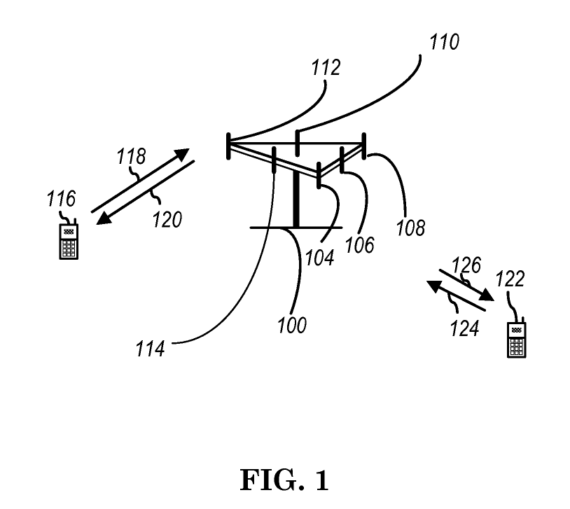

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), or some other terminology. An access terminal (AT) may also be called user equipment (UE), a wireless communication device, terminal, access terminal or some other terminology.

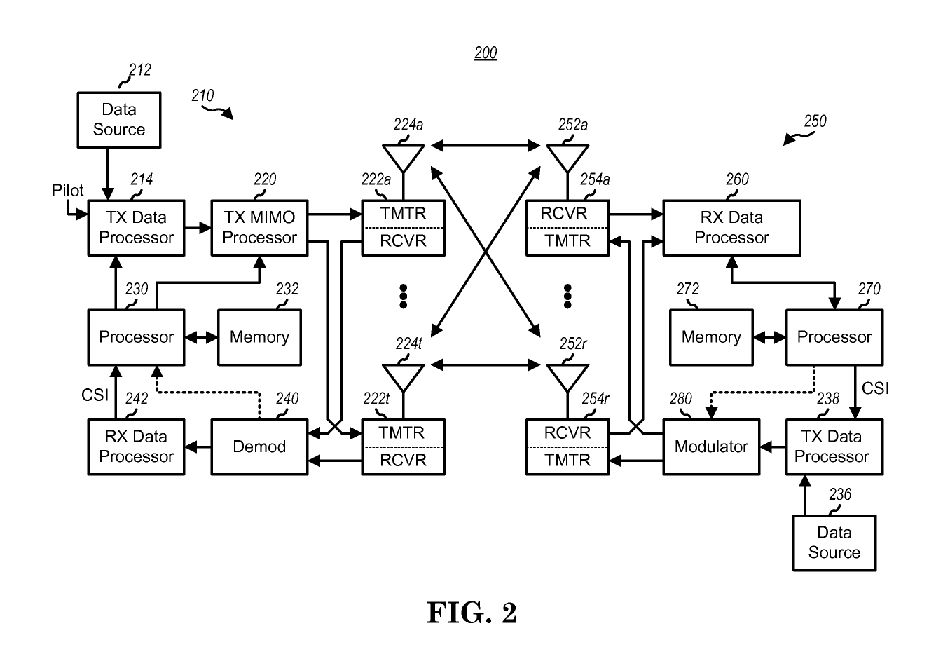

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

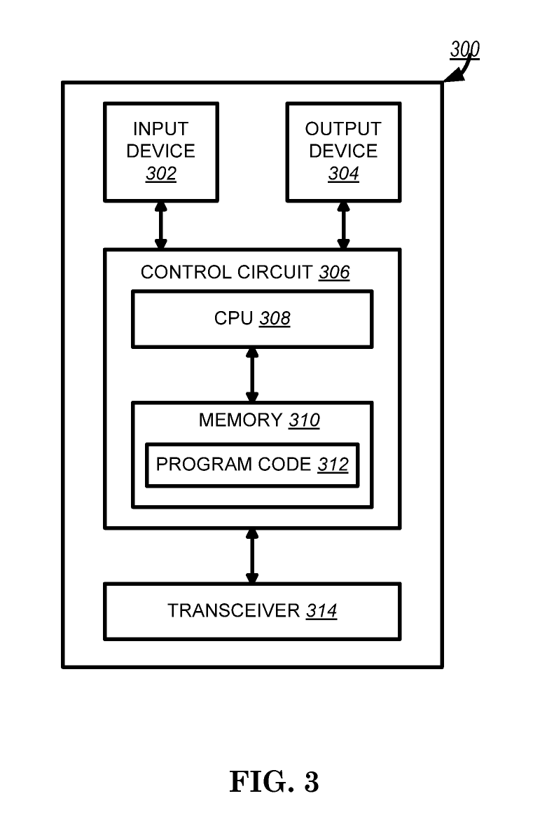

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

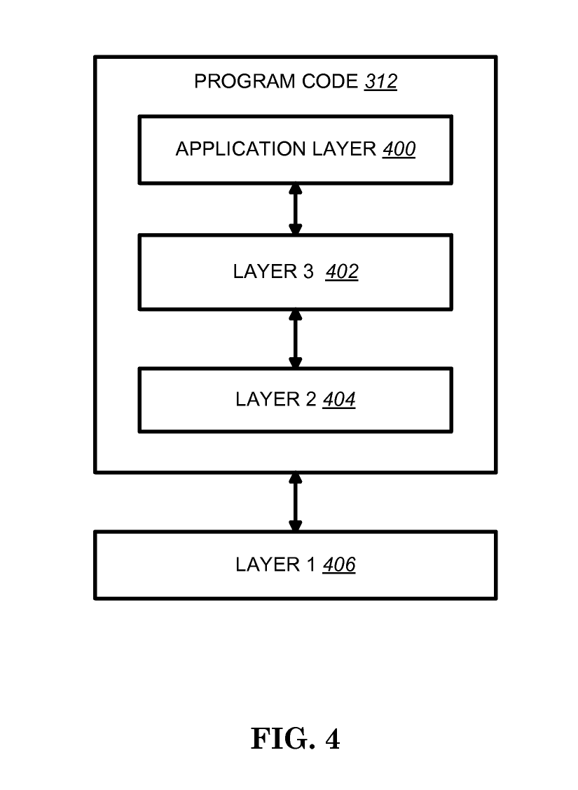

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE or LTE-A systems, the Layer 2 portion may include a Radio Link Control (RLC) layer and a Medium Access Control (MAC) layer. The Layer 3 portion may include a Radio Resource Control (RRC) layer.

Many use cases and potential requirements for ProSe (Proximity-based Service) are specified in 3GPP TR 22.803. One of the use cases specified in Section 5.1.6 of 3GPP TR 22.803 is “service continuity between infrastructure and E-UTRA ProSe Communication paths” as follows:

### 5.1.6 Service Continuity Between Infrastructure and E-UTRA ProSe Communication Paths

### 5.1.6.1 Description

In this use case UEs communicate initially via an infrastructure path, then via a ProSe Communication path and finally return to an infrastructure path.

### 5.1.6.2 Pre-Conditions

An operator offers a service which makes use of the ProSe feature, in which:
The operator is able to establish a new user traffic session using E-UTRA ProSe communication;
The operator is able to switch user traffic from an infrastructure communication path to an E-UTRA ProSe communication path.
   In addition, the following assumptions are made:
Mary and Peter use ProSe-enabled UEs;
Mary and Peter are subscribed to the same cellular operator;
Mary and Peter are currently residing on their HPLMN;
Mary and Peter are subscribed to an operator service that allows them to use ProSe;
Mary and Peter have performed ProSe discovery and initiation of ProSe communications.

### 5.1.6.3 Service Flows

Mary and Peter are engaged in a data session (including one or more flows) that is being routed over the MNO's core network infrastructure.
As Peter moves within proximity of Mary, one or more flows of the data session is switched to an E-UTRA ProSe communication path.
At some point later, the data session is switched back to the infrastructure path.
The user experience is such that the switching of the data path is not perceived by the users.
The user experience of the ongoing user traffic sessions is such that any un-switched data flows are not negatively impacted by the switching of other data flows.

### 5.1.6.4 Post-Conditions

### None

### 5.1.6.5 Potential Requirements

[PR.99] The operator shall be able to dynamically control the proximity criteria for ProSe communication. Examples of the criteria include: range, channel conditions, achievable QoS.
[PR.27] Subject to operator policy and user consent, the system shall be capable of establishing a new user traffic session with an E-UTRA ProSe Communication path, and maintaining both of the E-UTRA ProSe Communication path and the existing infrastructure path, when the UEs are determined to be in range allowing ProSe Communication. The UEs can be:
Served by the same PLMN, including when roaming;
Served by different PLMNs, including when roaming.
   Note: ProSe Communication between UEs served by different PLMNs can be subject to the availability of suitable radio resources (e.g., shared RAN in a MOCN/GWCN environment).
      [PR.28] The system shall be capable of moving a user traffic session from the infrastructure path to an E-UTRA ProSe Communication path, when the ProSe-enabled UEs are determined to be in range allowing ProSe Communication.
      [PR.29] The system shall be capable of monitoring the communication characteristics (e.g. channel condition, QoS of the path, volume of the traffic, etc.) on the E-UTRA ProSe communication path, regardless of whether there is data transferred via infrastructure path.
      [PR.30] The system shall be capable of moving a user traffic session from an E-UTRA ProSe communication path to an infrastructure path. At a minimum, this functionality shall support the case when the E-UTRA ProSe Communication path is no longer feasible.
      [PR.31] The user shall not perceive the switching of user traffic sessions between the E-UTRA ProSe Communication and infrastructure paths when triggered by the network.
      [PR.31.1] The user shall not perceive the switching of user traffic sessions between the E-UTRA ProSe Communication and infrastructure paths when triggered by the UE.
      [PR.32] The system shall be capable of switching each flow it is aware of between the E-UTRA ProSe Communication and the infrastructure paths, independently.
      [PR.33] The establishment of a user traffic session on the E-UTRA ProSe Communication path and the switching of user traffic between an E-UTRA ProSe Communication path and an infrastructure path are under control of the network.
      [PR.92] The HPLMN operator shall be able to authorize the ability of a UE to use ProSe Communication, separately for the HPLMN and for roaming in VPLMNs.
      [PR.93] The HPLMN operator shall be able to authorize the ability of a UE to use ProSe Communication to communicate with a ProSe-enabled UE served by a different PLMN.
      [PR.94] The VPLMN operator shall be able to turn on or off the ability for all the inbound roamers from a specific PLMN to use ProSe Communication.
      [PR.34] The Radio Access Network shall control the radio resources associated with the E-UTRA ProSe Communication path.
      [PR.35] The ProSe mechanism shall enable the operator to change the communication path of a user traffic session without negatively affecting the QoS of the session.
      [PR.36] The ProSe mechanism shall enable the operator to change the communication path of a user traffic session of a ProSe-enabled UE without negatively affecting the communication paths of other ongoing user traffic sessions of this or other ProSe-enabled UEs.
      [PR.37] The ProSe mechanism shall enable the operator to change the communication path of a user traffic session based upon the QoS requirements of the session and the QoS requirements of other ongoing sessions of this or other ProSe-enabled UEs.
      [PR.38] The system shall be capable of selecting the most appropriate communications path, according to operator preferences. The criteria for evaluation may include the following, although not restricted to:
System-specific conditions: backhaul link, supporting links or EPC performance;
Cell-specific conditions: for example cell loading;
ProSe Communication and infrastructure path conditions: communication range, channel conditions and achievable QoS;
Service-type conditions: APN, service discriminator.
   [PR.95] Both the HPLMN and VPLMN operators shall be able to charge for ProSe Communication.
   Two of the above requirements are noted here:
   [PR.28]: The system shall be capable of moving a user traffic session from the infrastructure path to an E-UTRA ProSe Communication path, when the ProSe-enabled UEs are determined to be in range allowing ProSe Communication.
   [PR.30] The system shall be capable of moving a user traffic session from an E-UTRA ProSe communication path to an infrastructure path. At a minimum, this functionality shall support the case when the E-UTRA ProSe Communication path is no longer feasible.

ProSe direct discovery (or D2D direct discovery) is introduced in 3GPP TS 23.303 as follows:

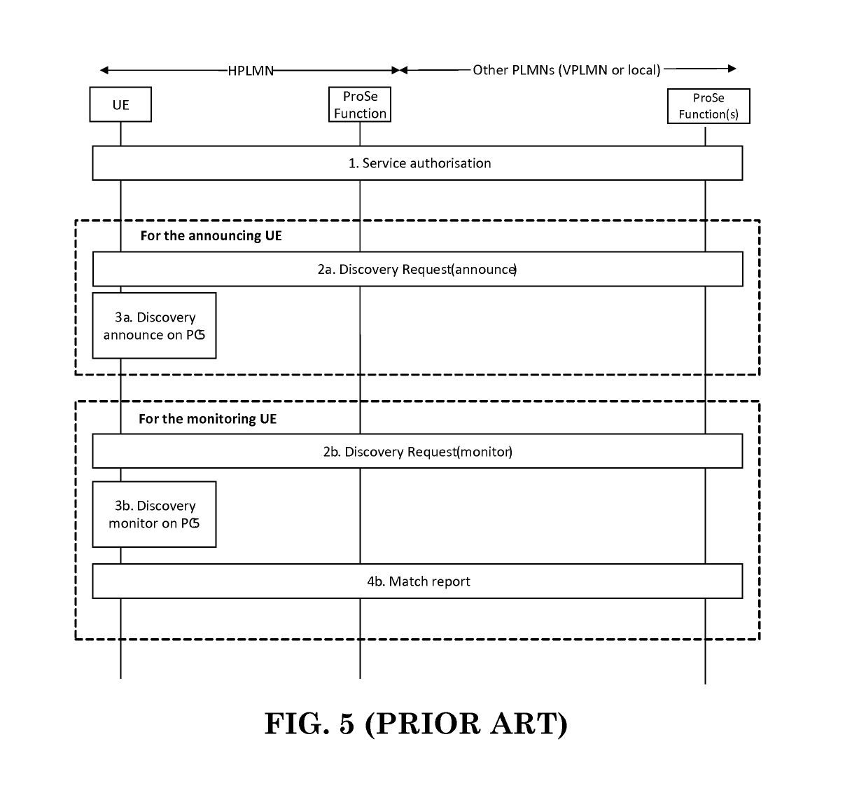

5.3.2 Overall procedure for ProSe Direct Discovery (Model A)
[Figure 5.3.2-1 entitled “Overall procedure for ProSe Direct Discovery” has been reproduced as FIG. 5]
1. Service authorisation for ProSe direct services is performed for ProSe Direct Discovery as defined in clauses 5.2, and 4.5.1.
   If the UE is authorised to announce:
2a. When the UE is triggered to announce then it sends a discovery request for announcing to the ProSe Function in HPLMN as defined in clauses 5.3.3.2 and 5.3.3.3.
3a. If the request is successful and is provided with ProSe Application Code then it starts announcing on PC5 interface.

NOTE 1: More details on the Access Stratum protocol of this step are provided in RAN specifications.

If the UE is authorised to monitor:
2b. When the UE is triggered to monitor, it sends a discovery request for monitoring to the ProSe Function as defined in clauses 5.3.3.4 and 5.3.3.5.
3b. If the request is successful and the UE is provided with a Discovery Filter consisting of ProSe Application Code(s) or mask(s) it starts monitoring for these ProSe Application Codes on the PC5 interface.
NOTE 2: More details on the Access Stratum protocol of this step are provided in RAN specifications.
4b. When the UE detects that one or more ProSe Application Code(s) that match the filter (see sub-clause 4.6.4.2), it reports the ProSe Application Code(s) to the ProSe Function as defined in clause 5.3.4.
   Non roaming direct discovery procedures cover the case where both the “announcing UE” and “monitoring UE” are served by their respective HPLMN. Roaming direct discovery procedures cover the other cases.

A UE (User Equipment) can transmit a “match report” to network to find a ProSe Application ID corresponding to a ProSe Application Code. An identity of the UE may be included in a match report as discussed in Section 5.3.4.1 of 3GPP TS 23.303 as follows:

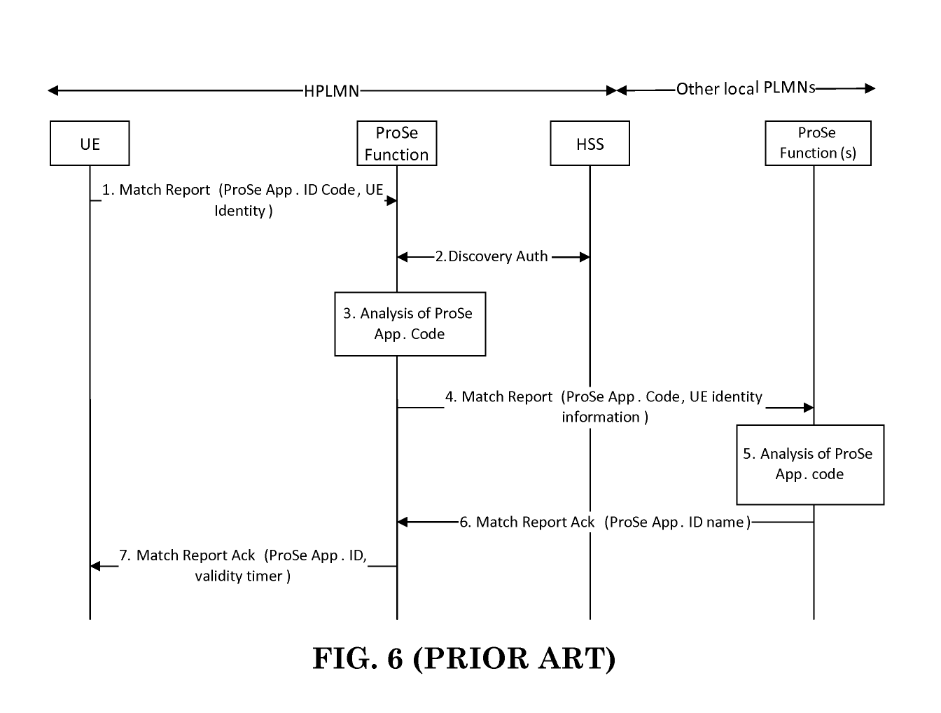

### 5.3.4.1 Match Report (Non-Roaming)

[Figure 5.3.4.1-1 entitled “Match report procedure (non-roaming)” has been reproduced as FIG. 6]
1. If the UE finds ProSe Application Code(s) that matches the Discovery Filters and does not have ProSe Application ID(s) already locally stored that correspond to this ProSe Application Code(s), it shall (re)establish a secure connection with the ProSe Function in HPLMN to which it shall then send a Match Report (ProSe Application Code(s), Discovery Filter ID(s), UE Identity) message to the ProSe Function in HPLMN. The ProSe Application Code is the code that the corresponding Discovery Filter of the UE matched. This request is always sent to the ProSe Function in HPLMN.
2. The ProSe Function shall check the context for this UE that contains its subscription parameters. The authorisation information also contains the PLMN that this UE is allowed to perform discovery.
3. The ProSe Function analyses the ProSe Application Code received from the UE.
   If the PLMN ID that assigned the given ProSe Application Code is another Local PLMN then steps 4-7 are executed, otherwise (i.e. the ProSe Application Code was assigned by HPLMN) only step 7 is executed:
4. The ProSe Function in HPLMN sends a Match Report (ProSe Application Code(s), UE identity) to the ProSe Function of the PLMN that assigned the ProSe Application Code. The UE identity information e.g. IMSI or MSISDN can be used by the ProSe Function in Local PLMN to perform charging.
5. The ProSe Function analyses the ProSe Application Code(s) received from the UE.
6. If the ProSe Application Code is confirmed then the ProSe Function in Local PLMN shall send Match Report Acknowledgement (ProSe Application ID Name(s), validity timer(s)). This message may also contain certain metadata corresponding to the ProSe Application ID Name e.g. postal address, phone number, URL etc.
7. The ProSe Function in HPLMN shall respond to the UE with Match Report Acknowledgment (ProSe Application ID(s), validity timer(s)). This message may also contain certain metadata corresponding to the ProSe Application ID Name e.g. postal address, phone number, URL etc. The validity timer(s) indicate for how long the ProSe Application ID(s) provided are going to be valid. The UE may store the mapping of ProSe Application Code(s) and corresponding ProSe Application ID(s) for the duration of their validity timer.

EPC (Evolved Packet Core)-level ProSe discovery is also introduced in 3GPP TS 23.303 as follows:

### 5.5.2 Overall Call Flow for EPC-Level ProSe Discovery

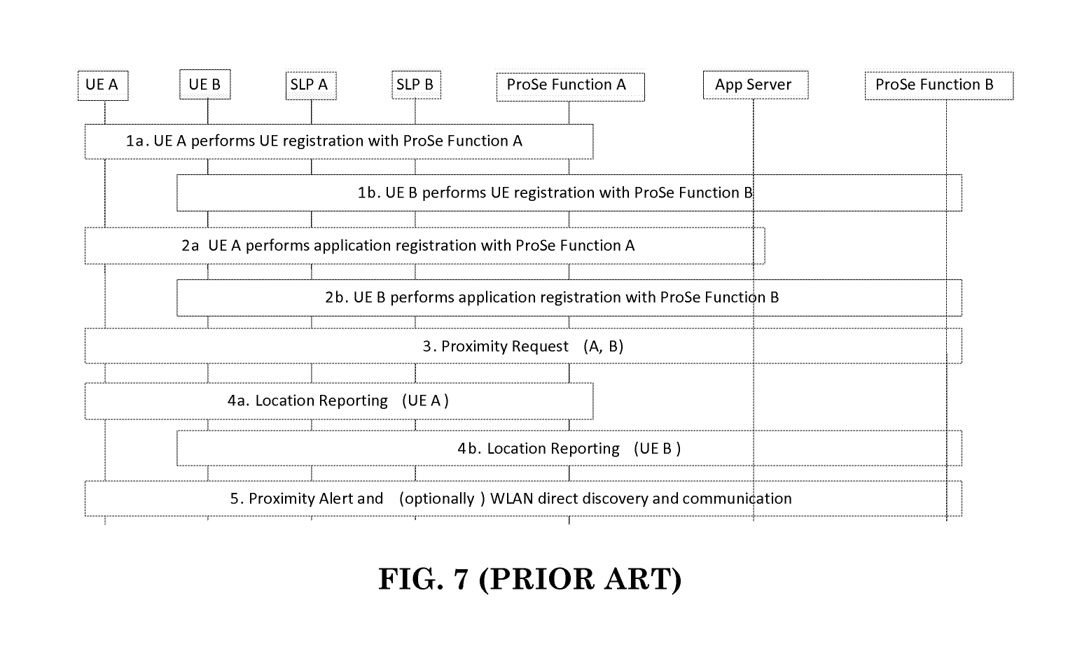

The overall call flow for EPC-level ProSe discovery and optional EPC support for WLAN direct discovery and communication is illustrated in Figure 5.5.2-1. Each procedural box is subsequently described in more detail as a separate call flow.

[Figure 5.5.2-1 entitled “Overall call flow for EPC-level ProSe discovery and optional EPC support for WLAN direct discovery and communication” has been reproduced as FIG. 7]
1. UEs perform UE registration for ProSe with the ProSe Function residing in their respective Home PLMNs;
2. UEs perform application registration for ProSe with the ProSe Function residing in their respective Home PLMNs;
3. UE A makes a proximity request for UE B, i.e. requests that it be alerted for proximity with UE B (possibly indicating a window of time during which the request is valid). In response, ProSe Function A requests location updates for UE A and UE B. These location updates can be periodic, based on a trigger, or a combination of both. To request location updates for UE A, ProSe Function A contacts SUPL Location Platform (SLP) A. To request location updates for UE B, ProSe Function A contacts ProSe Function B, which requests location updates for UE B from SLP B;
4. The UEs' locations are reported to their respective ProSe Functions intermittently. ProSe Function B forwards UE B's location updates to ProSe Function A based on the conditions set by ProSe Function A. Whenever ProSe Function A receives location updates for UE A and/or UE B, it performs proximity analysis on UE A and UE B's locations;
5. When ProSe Function A detects that the UEs are in proximity, it informs UE A that UE B is in proximity and (optionally) provides UE A with assistance information for WLAN direct discovery and communication with UE B. ProSe Function A also informs ProSe Function B, which in turn informs UE B of the detected proximity and (optionally) provides UE B with assistance information for WLAN direct discovery and communication with UE A.

A UE can transmit a “proximity request” to network in order to be alerted when the UE enters proximity with another UE as discussed in 3GPP TS 23.303 as follows:

### 5.5.5 Proximity Request

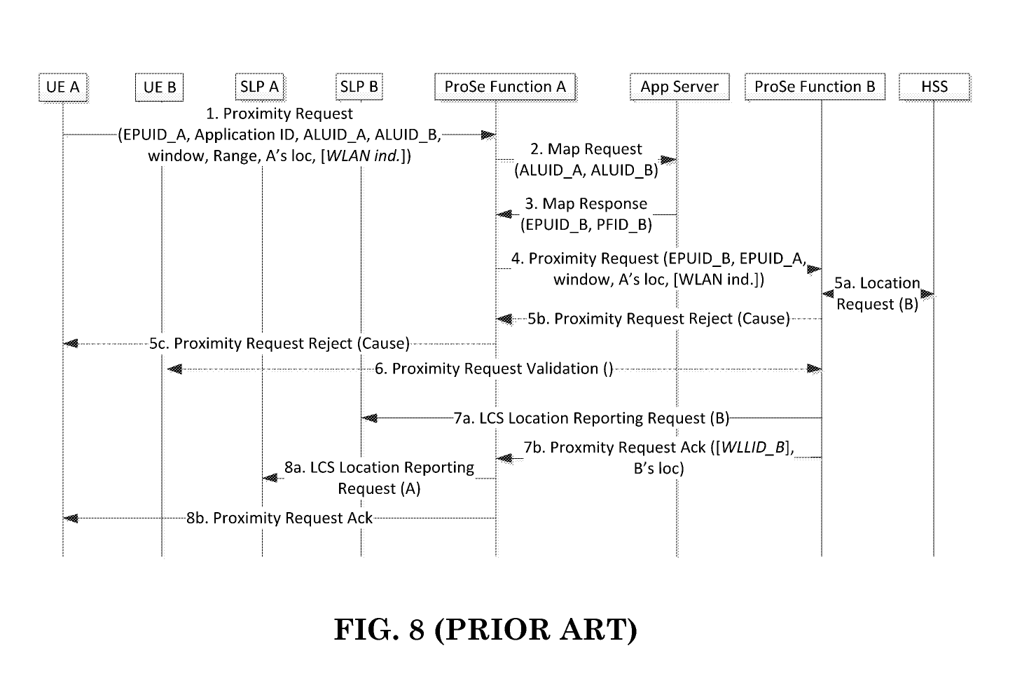

In order to request that it be alerted when it enters proximity with user B, UE A triggers the Proximity Request procedure, as illustrated in Figure 5.5.5-1.

[Figure 5.5.5-1 entitled “Proximity Request” has been reproduced as FIG. 8]
1. UE A sends a Proximity Request (EPUID_A, Application ID, ALUID_A, ALUID_B, window, Range, A's location, [WLAN indication]) message to ProSe Function A. The Application ID parameter identifies the 3rd party App Server platform. ALUID_A and ALUID_B are the Application Layer User IDs for users A and B, respectively. The window parameter indicates the time period during which the request is valid. Range is a requested range class for this application chosen from the set of allowed range classes. A's location is the current location of UE A with the best accuracy known by UE A. UE A may optionally request EPC support for WLAN direct discovery and communication with UE B by adding the WLAN indication.
2. ProSe Function A sends a Map Request (ALUID_A, ALUID_B) message to the App Server, requesting that it provide the EPC ProSe Subscriber ID for the targeted user B. ProSe Function A stores the Application Layer User IDs (ALUID_A and ALUID_B) until the execution of the Proximity Alert procedure described in clause 5.5.7, the Proximity Request Cancellation procedure described in clause 5.5.9 or until the expiry of the time window during which the request is valid.
3. The App Server checks user B's application-specific ProSe permissions, confirms that user A is allowed to discover user B, and sends a Map Response (EPUID_B PFID_B) message to ProSe Function A indicating user B's EPC ProSe Subscriber ID (EPUID_B) as well as the ProSe Function ID of ProSe Function B (PFID_B), ProSe Function A stores the EPUID_B and PFID_B until the execution of the Proximity Alert procedure described in clause 5.5.7, the Proximity Request Cancellation procedure described in clause 5.5.9 or until the expiry of the time window during which the request is valid.
4. ProSe Function A propagates the Proximity Request (EPUID_B, EPUID_A, window, A's location, [WLLID_A]) message to ProSe Function B, indicating a location update periodicity, trigger or both. A's location is the current location of UE A provided in step 1 expressed in in GAD shapes defined in TS 23.032 [3]. WLAN indication is included if UE A has requested EPC support for WLAN direct discovery and communication in step 1.
5. Based on EPUID_B received in the previous step, ProSe Function B retrieves subscriber B's record. ProSe Function B may request UE B's last known location via the HSS (step 5a). Based on the last known location of UE B obtained via the HSS and UE A's location and time window provided by ProSe Function A in step 4, ProSe Function B may determine that the users are unlikely to enter proximity within the requested time window and rejects the request by sending a Proximity Request Reject message towards UE A with an appropriate cause value (steps 5b and 5c), in which case the remaining steps of the procedure are skipped.
6. Depending on UE B's ProSe profile, UE B may be asked to confirm permission for the proximity request (e.g. user B may have temporarily disabled the ProSe function on UE B).
7. ProSe Function B requests location reporting on UE B from SLP B and acknowledges the proximity request to ProSe Function A and provides UE B's current location (if known). The WLAN Link Layer ID of UE B (WLLID_B) is included if UE A has requested EPC support for WLAN direct discovery and communication in step 1 and if UE B uses a permanent WLAN Link Layer ID.
8. ProSe Function A requests location reporting on UE A from SLP A. If UE A's current location is available and if UE B's location was included in step 7, ProSe Function A may decide to cancel the Proximity Request procedure if it determines that the UEs are unlikely to enter proximity within the requested time window. Otherwise ProSe Function A acknowledges the proximity request to UE A.

As discussed in 3GPP TS 23.303, the UE Location Reporting is used in general to provide location information to network as follows:

### 5.5.6 UE Location Reporting

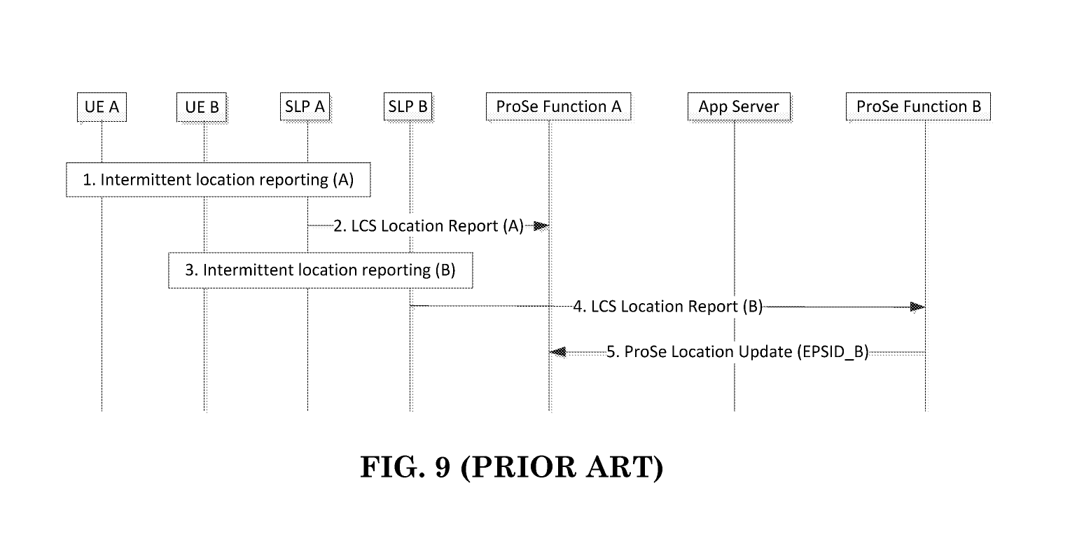

SLP A and SLP B configure UE A and UE B, respectively, to report their locations periodically, based on a trigger, or a combination of both depending on what ProSe Function A and ProSe Function B requested (see Figure 5.5.6-1).
[Figure 5.5.6-1 entitled “UE location reporting” has been reproduced as FIG. 9]
1-4. The locations of UE A and UE B are reported to their corresponding Prose Servers intermittently.
NOTE 1: If UE is engaged in multiple concurrent proximity request procedures, the location reports are grouped together by the SLP.
NOTE 2: The UE location reporting procedure is executed until the time window expires even if UE B “unfriends” UE A at application layer in the middle of an active proximity request.
5. Assuming that ProSe Function A is in charge of determining proximity, ProSe Function B forwards UE B's location to ProSe Function A periodically, based on a trigger criterion, or a combination of both as requested by ProSe Function A. The UE location information exchanged between ProSe Functions are expressed in GAD shapes defined in TS 23.032 [3]. ProSe Function A may decide to cancel the Proximity Request procedure if it determines that the UEs are unlikely to enter proximity within the requested time window.

Based on ProSe direct communication discussed in 3GPP TS 23.303, it is generally assumed that the switch of the communication path of a UE's traffic session between an infrastructure path and a ProSe direct communication (or D2D communication) path can be determined by network (e.g., eNB). When the network is aware of that a D2D communication path for some traffic session is viable, the network may decide to use D2D communication for the traffic session. The decision may need to rely on some UE assistance. For example, a first UE may transmit a report to network to indicate that a second UE is in the proximity of the first UE (for example, when the first UE discovers the second UE). An identity of the second UE may be included in the report.

However, having proximity information may not be sufficient for network to decide whether to use a D2D communication because the discovery of a UE in proximity may not imply that a D2D communication path toward the UE is viable. For example, the D2D communication range is not the same as the D2D discovery range, or the QoS requirement of D2D communication is higher than the QoS of the D2D discovery. In addition, it is difficult for the network to decide how to allocate proper resources for the D2D communication without further information.

It is generally assumed that a first UE can transmit a report to a network node to indicate that a second UE is in proximity. In order to let network decide whether to use a D2D communication path or not properly and have better D2D communication resource utilization, the general concept of the invention is to include location information of the first UE in the report. The knowledge of location of the first UE enables the network to better understand whether it is suitable to use D2D communication between the first UE and another UE (e.g., the second UE). The report may also assist the network to know the location of the second UE (e.g., enables network to trigger a UE location reporting procedure for the second UE). The network could therefore decide whether to use a D2D communication path properly. Furthermore, a proper (time/frequency) resource for D2D communication could be selected based on the location information (e.g., to avoid interference). Besides, the reporting of the UE location could be performed more efficiently, and unnecessary signaling overhead could be prevented.

More specifically, an identity of the first UE may be included in the report. An identity of the second UE may be included in the report. The first UE and the second UE may be ProSe-enabled. A channel condition of a D2D link between the first UE and the second UE may be included in the report. The network may be an eNB, a ProSe function, or a ProSe server.

Furthermore, the second UE may be determined to be in proximity of the first UE if the second UE is discovered by the first UE by D2D direct discovery. The transmission of the report may be initiated upon the first UE discovers the second UE by D2D discovery. The transmission of the report may be initiated when the first UE intends to initiate a communication with the second UE. The communication may be a D2D communication. The communication may be an E-UTRAN communication. The first UE may be communicating with the second UE via an infrastructure path. The transmission of the report may be initiated when the first UE changes a serving cell, e.g. due to handover, or connection re-establishment. The report may be a match report (as specified in 3GPP TS 23.303). Alternatively, the report may be used to request network to initiate a UE location reporting procedure for the first UE. Alternatively, the report may be used to request network to initiate a UE location reporting procedure for the second UE. Alternatively, the report may be a proximity request (as specified in 3GPP TS 23.303). Alternatively, the report may be a RRC message.

In addition, the location information may comprise at least one of the following information: detailed location information (as specified in 3GPP TS 36.331), IE LocationInfo (as specified in 3GPP TS 36.331 and TS 36.355), information included in IE LocationInfo (as specified in 3GPP TS 36.331 and TS 36.355), information about latitude and longitude, and/or information that could be used to derive a UE's location.

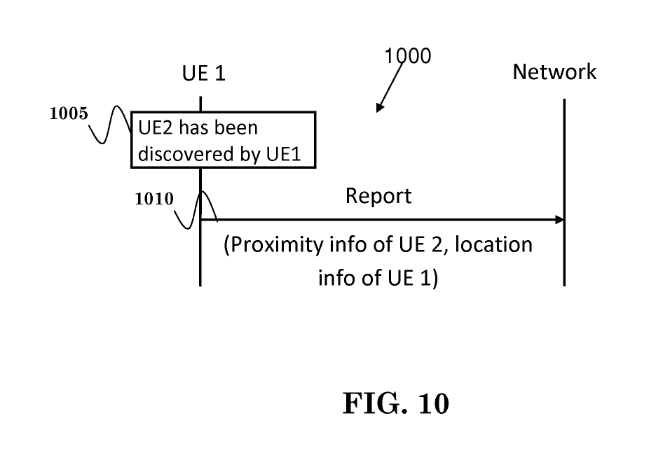

FIG. 10 is a message flow diagram 1000 illustrating an exemplary signal flow according to one embodiment. As shown in FIG. 10, a first UE (UE 1) discovers a second UE (UE 2) in step 1005. In step 1010, the first UE transmits a report that includes the proximity information of the second UE and the location information of the first UE to the network.

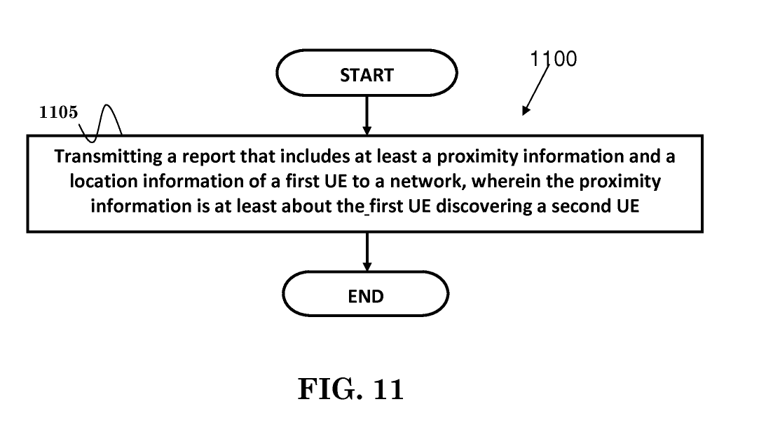

FIG. 11 is a flow chart 1100 in accordance with one exemplary embodiment from the perspective of a first UE. In step 1105, the first UE transmits a report that includes at least a proximity information and a location information of the first UE to a network, wherein the proximity information is at least about the first UE discovering a second UE. As an example, the proximity information may be the identity of the second UE.

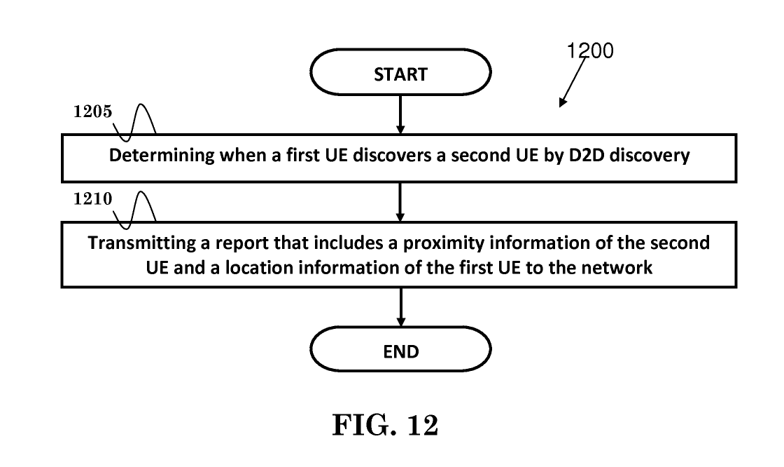

FIG. 12 is a flow chart 1200 in accordance with one exemplary embodiment from the perspective of a first UE. In step 1205, it is determined when the first UE discovers a second UE by D2D discovery. In step 1210, the first UE transmits a report that includes a proximity information of the second UE and a location information of the first UE to the network. The transmission of the report is initiated when the first UE discovers the second UE by D2D discovery.

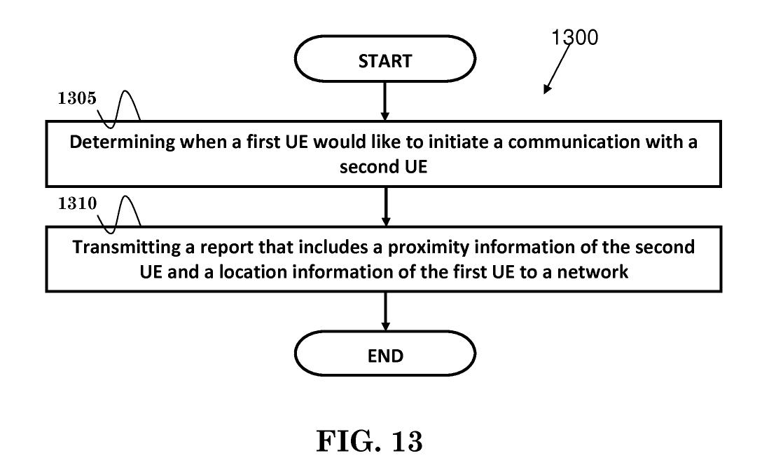

FIG. 13 is a flow chart 1300 in accordance with one exemplary embodiment from the perspective of a first UE. In step 1305, it is determined when the first UE would like to initiate a communication with a second UE. In step 1310, the first UE transmits a report that includes a proximity information (such as the identity of a second UE) and a location information of the first UE to the network. The transmission of the report is initiated when the first UE would like to initiate a communication with the second UE.

In one embodiment, the communication could be a D2D communication or an E-UTRAN (Evolved Universal Terrestrial Radio Access Network) communication. Furthermore, the first UE communicates with the second UE via an infrastructure path, such as a path between a UE and an eNB (evolved Node B).

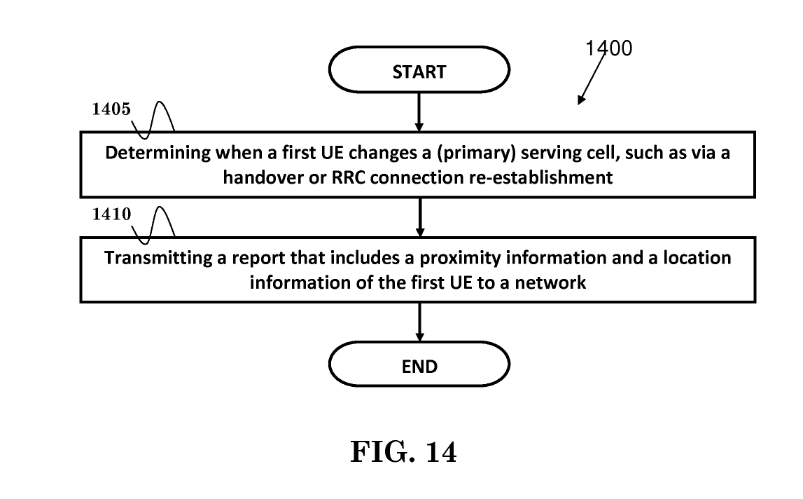

FIG. 14 is a flow chart 1400 in accordance with one exemplary embodiment from the perspective of a first UE. In step 1405, it is determined when the first UE changes a (primary) serving cell, such as via a handover or RRC (Radio Resource Control) connection re-establishment. In step 1410, the first UE transmits a report that includes a proximity information of a second UE and a location information of the first UE to a network. The transmission of the report is initiated when the first UE changes a (primary) serving cell, such as via a handover or RRC connection re-establishment.

Referring back to FIGS. 3 and 4, the device 300 includes a program code 312 stored in memory 310 of the first UE. The CPU 308 could execute program code 312 to enable a first UE to transmit a report that includes at least a proximity information and a location information of the first UE to a network, wherein the proximity information is at least about the first UE discovering a second UE. The transmission of the report could be initiated (i) when the first UE discovers the second UE by D2D discovery, (ii) when the first UE intends to initiate a communication with the second UE, and/or (iii) when the first UE changes a (primary) serving cell, such as via a handover or RRC connection re-establishment.

In addition, the CPU 308 can execute the program code 312 to perform all of the above-described actions and steps or others described herein.

In one embodiment, the location information could include detailed location information, some or all information of IE (Information Element) LocationInfo (as disclosed in 3GPP TS 36.331 and TS 36.355), information about latitude and longitude, and/or information that could be used to derive a location. The IE LocationInfo is disclosed in 3GPP TS 36.331 as follows:

The IE LocationInfo is used to transfer detailed location information available at the UE to correlate measurements and UE position information.

LocationInfo information element

```
-- ASN1START
LocationInfo-r10 : : = SEQUENCE {
  locationCoordinates-r10  CHOICE {
    ellipsoid-Point-r10  OCTET STRING,
    ellipsoidPointWithAltitude-r10  OCTET STRING,
```

. . . ,

```
    ellipsoidPointWithUncertaintyCircle-r11 OCTET STRING,
    ellipsoidPointWithUncertaintyEllipse-r11  OCTET STRING,
    ellipsoidPointWithAltitudeAndUncertainty  OCTET STRING,
    Ellipsoid-r11
    ellipsoidArc-r11  OCTET STRING,
    polygon-r11 OCTET STRING
  },
```

| | | |
|---|---|---|
| horizontalVelocity-r10 | OCTET STRING | OPTIONAL, |
| gnss-TOD-msec-r10 | OCTET STRING | OPTIONAL, |
| . . . | | |
| } | | |
| -- ASN1STOP | | |

### LocationInfo Field Descriptions

### EllipsoidArc

Parameter EllipsoidArc defined in TS36.355 [54]. The first/leftmost bit of the first octet contains the most significant bit.

### Ellipsoid-Point

Parameter Ellipsoid-Point defined in TS36.355 [54]. The first/leftmost bit of the first octet contains the most significant bit.

### EllipsoidPointWithAltitude

Parameter EllipsoidPointWithAltitude defined in TS36.355 [54]. The first/leftmost bit of the first octet contains the most significant bit.

### EllipsoidPointWithAltitudeAndUncertaintyEllipsoid

Parameter EllipsoidPointWithAltitudeAndUncertaintyEllipsoid defined in TS36.355 [54]. The first/leftmost bit of the first octet contains the most significant bit.

### EllipsoidPointWithUncertaintyCircle

Parameter Ellipsoid-Point WithUncertaintyCircle defined in TS36.355 [54]. The first/leftmost bit of the first octet contains the most significant bit.

### EllipsoidPointWithUncertaintyEllipse

Parameter EllipsoidPointWithUncertaintyEllipse defined in TS36.355 [54]. The first/leftmost bit of the first octet contains the most significant bit.

### Gnss-TOD-msec

Parameter Gnss-TOD-msec defined in TS36.355 [54]. The first/leftmost bit of the first octet contains the most significant bit.

### Horizontal Velocity

Parameter Horizontal Velocity defined in TS36.355 [54]. The first/leftmost bit of the first octet contains the most significant bit.

### Polygon

Parameter Polygon defined in TS36.355 [54]. The first/leftmost bit of the first octet contains the most significant bit.

In one embodiment, the report may be a match report, an RRC (Radio Resource Control) message, or a proximity request for EPC (Evolved Packet Core)-level ProSe discovery (as disclosed in 3GPP TS 23.303). Furthermore, the report could be used to request network to initiate a UE location reporting procedure for the first UE and/or for the second UE. Also, the report could include an identity of the first UE, a location information of the second UE, and/or a channel condition of a D2D link between the first UE and the second UE.

In one embodiment, the proximity information may be an identity of the second UE. In one embodiment, the first UE could be ProSe (Proximity-based Service) enabled. Furthermore, the second UE could be ProSe enabled. In addition, the network could be an eNB, a ProSe function, or a ProSe server.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for providing a proximity information in a first UE (User Equipment), comprising:
transmitting a report that includes at least the proximity information and a location information of the first UE to a network,
wherein the proximity information is at least about the first UE discovering a second UE.

2. The method of claim 1, wherein the first UE discovers the second UE via D2D (Device to Device) direct discovery.

3. The method of claim 1, wherein the transmission of the report is initiated when the first UE discovers the second UE by D2D discovery.

4. The method of claim 1, wherein the transmission of the report is initiated when the first UE intends to initiate a communication with the second UE.

5. The method of claim 4, wherein the communication is a D2D communication or an E-UTRAN (Evolved Universal Terrestrial Radio Access Network) communication.

6. The method of claim 1, wherein the transmission of the report is initiated when the first UE changes a (primary) serving cell.

7. The method of claim 1, wherein the report is a match report, an RRC (Radio Resource Control) message, or a proximity request for EPC (Evolved Packet Core)-level ProSe (Proximity-based Service) discovery.

8. The method of claim 1, wherein the report further includes an identity of the first UE, a location information of the second UE, and/or a channel condition of a D2D link between the first UE and the second UE.

9. The method of claim 1, wherein the proximity information is an identity of the second UE.

10. The method of claim 1, wherein the network is an eNB (evolved Node B), a ProSe (Proximity-based Service) function, or a ProSe server.

11. A communication device for providing a proximity information in a first UE (User Equipment) of a wireless communication system, the communication device comprising:
a control circuit;
a processor installed in the control circuit; and
a memory installed in the control circuit and operatively coupled to the processor;
wherein the processor is configured to execute a program code stored in the memory to provide proximity information by:
transmitting a report that includes at least the proximity information and a location information of the first UE to a network,
wherein the proximity information is at least about the first UE discovering a second UE.

12. The communication device of claim 11, wherein the first UE discovers the second UE via D2D (Device to Device) direct discovery.

13. The communication device of claim 11, wherein the transmission of the report is initiated when the first UE discovers the second UE by D2D discovery.

14. The communication device of claim 11, wherein the transmission of the report is initiated when the first UE intends to initiate a communication with the second UE.

15. The communication device of claim 14, wherein the communication is a D2D communication or an E-UTRAN (Evolved Universal Terrestrial Radio Access Network) communication.

16. The communication device of claim, wherein the transmission of the report is initiated when the first UE changes a (primary) serving cell.

17. The communication device of claim 11, wherein the report is a match report, an RRC (Radio Resource Control) message, or a proximity request for EPC (Evolved Packet Core)-level ProSe (Proximity-based Service) discovery.

18. The communication device of claim 11, wherein the report further includes an identity of the first UE, a location information of the second UE, and/or a channel condition of a D2D link between the first UE and the second UE.

19. The communication device of claim 11, wherein the proximity information is an identity of the second UE.

20. The communication device of claim 11, wherein the network is an eNB (evolved Node B), a ProSe (Proximity-based Service) function, or a ProSe server.
